(19) United States
(12) Patent Application Publication
(10) Pub. No.: US 2026/0299882 A1
(43) Pub. Date: Oct. 1, 2026

(54) NUMBER ENCODING FOR ENHANCED LARGE LANGUAGE MODEL (LLM) NUMERICAL REASONING

(71) Applicant: International Business Machines Corporation, Armonk, NY (US)

(72) Inventors: ELIYAHU SCHWARTZ, Haifa (IL); Assaf Arbelle, Lehvot Haviva (IL); LESHEM CHOSHEN, Jerusalem (IL)

(21) Appl. No.: 19/093,112

(22) Filed: Mar. 27, 2025

(51) Int. Cl. G06F 7/50

(52) U.S. Cl. CPC G06F 7/50

(57) ABSTRACT

A numerical value is obtained and the numerical value is preprocessed by adding a digit count before the numerical value to generate a modified numerical value, the digit count indicating a count of digits in the numerical value. The modified numerical value is provided to a machine learning model pretrained to understand the modified numerical value that comprises the digit count and the modified numerical value is processed using the pre-trained machine learning model.

### BACKGROUND

The present invention relates generally to the electrical, electronic and computer arts and, more particularly, to machine learning.

Language models struggle with handling numerical data and performing arithmetic operations. It is hypothesized that this limitation can be partially attributed to non-intuitive textual numbers representation. When a digit is read or generated by a causal language model, it does not know its place value (e.g. thousands vs. hundreds) until the entire number is processed. Thus, reading numbers in a causal manner from left to right is sub-optimal for large language models (LLMs), as it is for humans.

### BRIEF SUMMARY

Principles of the invention provide systems and techniques for number encoding for enhanced large language model numerical reasoning. In one aspect, an exemplary method includes the operations of obtaining a numerical value; preprocessing the numerical value by adding a digit count before the numerical value to generate a modified numerical value, the digit count indicating a count of digits in the numerical value; providing the modified numerical value to a machine learning model pretrained to understand the modified numerical value that comprises the digit count; and processing the modified numerical value using the pre-trained machine learning model.

In one aspect, a computer program product comprises one or more tangible computer-readable storage media and program instructions stored on at least one of the one or more tangible computer-readable storage media, the program instructions executable by a processor, the program instructions comprising obtaining a numerical value; preprocessing the numerical value by adding a digit count before the numerical value to generate a modified numerical value, the digit count indicating a count of digits in the numerical value; providing the modified numerical value to a machine learning model pretrained to understand the modified numerical value that comprises the digit count; and processing the modified numerical value using the pre-trained machine learning model.

In one aspect, an apparatus comprises a memory and at least one processor, coupled to the memory, and operative to perform operations comprising obtaining a numerical value; preprocessing the numerical value by adding a digit count before the numerical value to generate a modified numerical value, the digit count indicating a count of digits in the numerical value; providing the modified numerical value to a machine learning model pretrained to understand the modified numerical value that comprises the digit count; and processing the modified numerical value using the pre-trained machine learning model.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
generalizability: unlike solutions focused on specific arithmetic tasks, exemplary techniques are designed for general language modeling evolving text with numerical values;
simplicity: exemplary techniques do not require complex architectural changes or elaborate prompting techniques (can be implemented through simple text preprocessing and post processing);
pretraining compatibility: exemplary techniques can be easily integrated into the pretraining process of large language models (unlike some post hoc solutions);
informs a large language model in advance about what the place value of a digit is before it is read;
acts as a Chain of Thought (CoT), encouraging the model to perform some reasoning before it begins to predict digits (when the model is generating a number (including integers, floating point numbers and the like), it needs to first reason about what is going to be the total number of digits);
handling model errors: a digit count prefix is used to detect generation errors where the predicted digit count does not match the number of digits actually generated; and
reformatting techniques that do not necessitate any alterations to the model's architecture (it can be accomplished through text pre-and post-processing based on regular expressions).

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A is a flowchart for an exemplary method for performing numerical encoding during training, in accordance with exemplary embodiments;

FIG. 1B is a flowchart for an exemplary method for performing numerical encoding during inferencing, in accordance with exemplary embodiments;

FIG. 2A is a table that illustrates arithmetic tasks accuracy of a conventional language model with NumeroLogic encoding, in accordance with exemplary embodiments;

FIG. 2B is a table that illustrates arithmetic tasks accuracy of a conventional foundational model with NumeroLogic encoding, in accordance with exemplary embodiments;

FIG. 2C is a table that illustrates the massive multitask language understanding (MMLU) accuracy change due to NumeroLogic encoding on tasks from different fields, in accordance with exemplary embodiments;

FIG. 2D is a table that illustrates MMLU accuracy change due to NumeroLogic encoding on tasks with and without numbers, in accordance with exemplary embodiments;

FIG. 2E is a table that illustrates the results of the effect of encoding the equation's operands vs. the result, in accordance with exemplary embodiments;

FIG. 2F is a table that illustrates the results of using different encoding alternatives for 3-digit multiplication, in accordance with exemplary embodiments;

FIG. 3 illustrates MMLU accuracy of the conventional foundational model, in accordance with exemplary embodiments;

FIG. 4 depicts a computing environment according to an embodiment of the present invention; and

FIG. 5 shows an exemplary code snippet, according to an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Language models struggle with handling numerical data and performing arithmetic operations. When a digit is read or generated by a causal language model, it does not know its place value (e.g. thousands vs. hundreds) until the entire number is processed. The LLM has to reach the final digits of the number before it can infer the place value of the first digit. To address this issue, one or more embodiments advantageously provide an adjustment to how numbers are represented by including the count of digits in a numerical value before each number. For instance, instead of the integer “42”, “2:42” is used as the new format. This formatting approach, referred to NumeroLogic herein, offers an added advantage in number generation by serving as a Chain of Thought (CoT). (As used herein, references to ‘NumeroLogic’ are to be understood as references to an exemplary embodiment of the invention and elements described in connection with such an exemplary embodiment are not necessarily present in other embodiments. The skilled person will be familiar with techniques that employ a series of intermediate reasoning steps, by way of example, and not limitation, the Chain of Thought approach, and, given the teachings herein, can adapt such known techniques that employ a series of intermediate reasoning steps to implement aspects of the invention.) By requiring the model to consider the number of digits first, it enhances the reasoning process before generating the actual number. Arithmetic tasks are used to demonstrate the effectiveness of the NumeroLogic formatting. The applicability of NumeroLogic to general natural language modeling is demonstrated, improving language understanding performance in the massive multitask language understanding (MMLU) benchmark. Please note that references herein to NumeroLogic are to be understood as references to exemplary embodiment(s) and the scope of the invention is defined by the appended claims.

### Introduction

Large Language Models (LLMs) struggle with numerical and arithmetical tasks. Despite continuous improvements, even the most advanced models still exhibit poor performance when confronted with tasks such as multiplying 3-digit numbers. Recent studies have proposed techniques to improve arithmetic tasks in LLMs, such as the Chain of Thought (CoT) method, which pushes the model to anticipate the entire sequence of algorithmic steps rather than just the final output. While these strategies offer valuable insights into the capabilities of LLMs, they primarily concentrate on post-hoc solutions for specific arithmetic challenges and do not present a practical solution for pretraining LLMs.

It is hypothesized that one of the challenges LLMs face when dealing with numerical tasks is the textual representation of numbers. In many conventional decoder-based LLMs, each token attends only to previous tokens. When a model “reads” a token representing a digit (or multiple digits), it cannot tell its place value, i.e. ‘1’ can represent 1 million, 1 thousand, or a single unit. Only when reaching the end of the number might the model update its representation of the previous digit tokens to be related to their real place value.

To address this issue, one or more embodiments advantageously provide a reformatting technique which involves adding the number of digits as a prefix to numbers. This allows the model to know in advance what the place value of a digit is before it is read. This change also offers another benefit: when the model is generating a number, it typically needs to first reason about what is going to be the number of digits. This acts as a Chain of Thought (CoT), encouraging the model to perform some reasoning before it begins to predict digits. Implementing the advantageous reformatting according to one or more embodiments does not necessitate any alterations to the model's architecture; it can be accomplished through text pre-and post-processing based on regular expressions.

It was demonstrated that exemplary embodiments enhance the numerical abilities of LLMs across both small and larger models (up to 7 billion (B) parameters). This enhancement is showcased through supervised training on arithmetic tasks and its application in self-supervised causal language modeling to enhance general language comprehension.

### Numerologic Technique

NumeroLogic is a technique for boosting causal numerical capabilities of machine learning models, such as LLMs. The concept involves adding a digit count before numbers, enabling the model to know the place values of digits before reaching the final digits of a number. Additionally, since the model typically needs to predict the total number of digits before generating a number, the system is configured to act as a simplified CoT, prompting it to reason about the number that is going to be generated.

Special tokens are added to help represent numbers with the number-of-digit prefix, such as “<startnumber>”, “<midnumber>”, and “<endnumber>” (or, for simplicity, “<sn>”, “<mn>”, and “<en>”). For floating point numbers, the prefix includes both the number of digits of the integer part and the decimal part. For example, “42” is replaced by “<sn>2<mn>42<en>” and “3.14” is replaced by “<sn>1.2<mn>3.14<en>”. When using the LLM to generate numbers, the information about the number of digits is disregarded and only the generated number itself is retained. It may be feasible to leverage the additional information to identify discrepancies, wherein the model predicts a certain digit count but produces a number with a different count of digits.

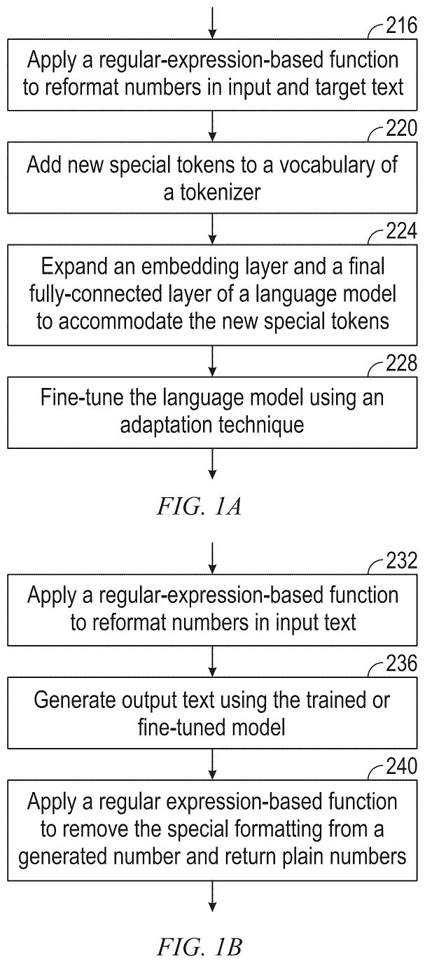

FIG. 1A is a flowchart for an exemplary method for performing numerical encoding during training, in accordance with exemplary embodiments. In exemplary embodiments, preprocessing is performed where, before tokenization, a regular expression-based function is applied to reformat all numbers in the input and target text (operation 216). New special tokens for facilitating the reformatted numbers are added to the tokenizer's vocabulary (operation 220). The embedding layer and final fully-connected layer are expanded to facilitate a language model accommodating the new tokens of the vocabulary (operation 224). (For example, one or a few new entries are added to the corresponding tensile to accommodate the new tokens of the vocabulary.) In exemplary embodiments, for pretrained models, techniques like LoRA (Low-Rank Adaptation) are used to fine-tune the model on the new format (operation 228).

FIG. 1B is a flowchart for an exemplary method for performing numerical encoding during inferencing, in accordance with exemplary embodiments. During inferencing, a regular expression-based function is applied to reformat numbers in the input text (operation 232). Output text is generated using the trained or fine-tuned model (operation 236). After generation, a regular expression-based function is applied to remove the special formatting from the number generated by the machine learning model and return plain numbers (operation 240).

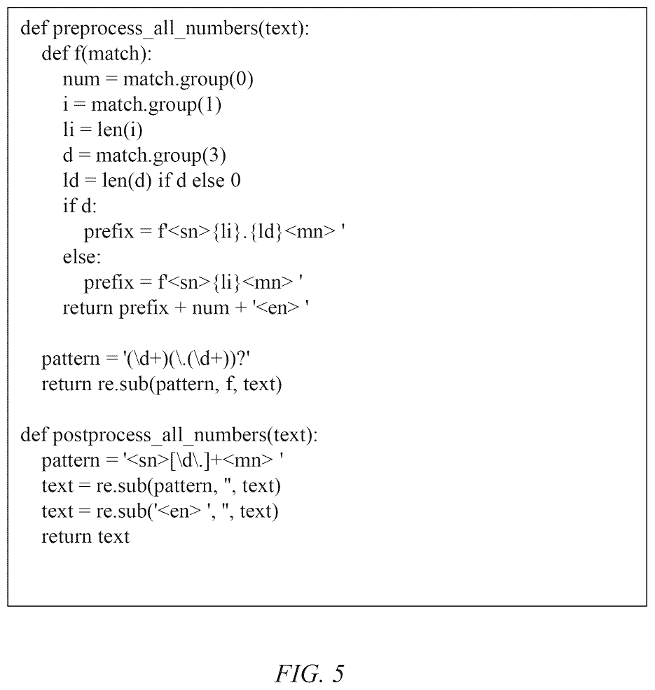

The exemplary NumeroLogic approach includes basic text pre-processing and post-processing steps that occur before and after the tokenizer's encoding and decoding methods, respectively. Both can be implemented based on regular expressions, referring to FIG. 5, where the def preprocess_all_numbers code corresponds to operation 216 and the def postprocess_all_numbers code corresponds to operation 232.

For small transformers (such as a first conventional model), all parameters were trained from scratch with character-level tokenization. For small transformers, the special tokens were also replaced with single characters, that is, “<sn>”, “<mn>”, and “<en>” were replaced with “{”, “:”, and “}”, respectively. In exemplary embodiments, for larger transformers, the technique begins with pretrained models. The new special tokens are added to the tokenizer's vocabulary and the embedding layer and the final fully connected layer are expanded to fit the new vocabulary size. When continuing training on causal language modeling or fine-tuning on supervised arithmetic tasks, conventional adaptation techniques are used, where low-rank adaptation (LoRA) is a non-limiting example. LoRA is applied for the attention block projection matrices (Q, K, V, O) and the modified embedding layer and the final fully-connected layer in full rank are trained.

### Experiments

To test the effect of NumeroLogic, several experiments were conducted. First, supervised training of a small language model (the conventional language model) was tested on various arithmetic tasks. The scalability to larger models (such as the conventional foundational model) was then tested. Finally, self-supervised pretraining of the conventional foundational model was tested with the suggested formatting and tested on general language understanding tasks.

### Arithmetic Tasks With Small Model

The conventional language model was trained from scratch in a supervised manner jointly on five arithmetic tasks: addition, subtraction, multiplication, sine, and square root. Addition and subtraction were performed with up to 3-digit integer operands. Multiplications were performed with up to 2-digit integer operands. Sine and square root were performed with 4 decimal-places floating point operands and results. The operand range for sine is within [−π/2, π/2]. The operand range for the square root is within [0, 10]. The model was trained in a multi-task fashion on all five tasks, with 10,000 training samples for each task except for multiplication, for which 3,000 samples were used.

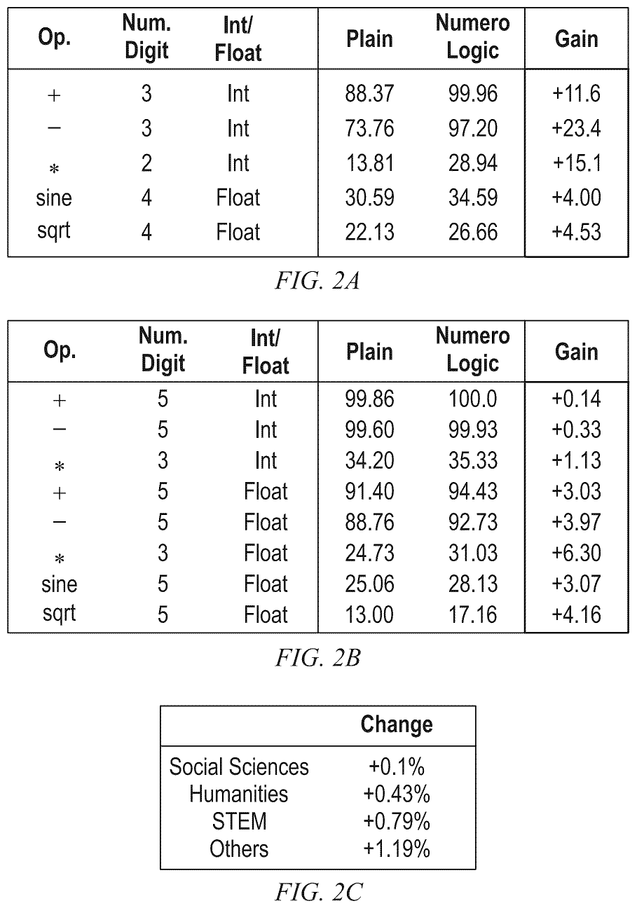

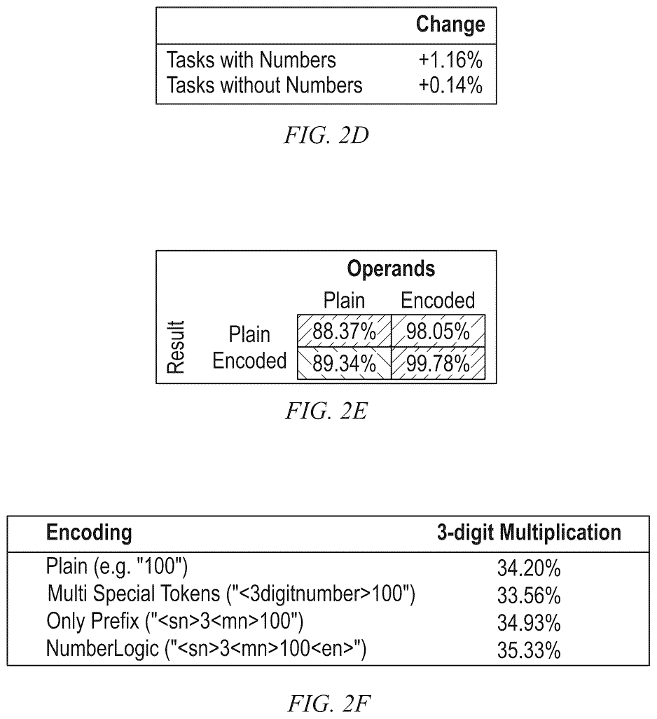

FIG. 2A compares the results of training with plain numbers and training with the NumeroLogic encoding, in accordance with exemplary embodiments. For addition and subtraction, a model trained with plain numbers reached 88.37% and 73.76% accuracy, respectively, while, with a model trained with the NumeroLogic encoding, the tasks are almost solved (99.96% and 97.2%). For multiplication, a more than doubling of the accuracy was observed, from 13.81% to 28.94%. Furthermore, for the floating-point operations, sine and square root, a significant improvement of 4% for both tasks was observed.

FIG. 2A is a table that illustrates arithmetic tasks accuracy of the conventional language model with NumeroLogic encoding, in accordance with exemplary embodiments. A single model is jointly trained for all tasks. The encoding produces high accuracy gains for all tasks. (Op. represents the performed operation, int signifies an integer and float signifies a floating-point value.)

FIG. 2B is a table that illustrates arithmetic tasks accuracy of the conventional foundational model with NumeroLogic encoding, in accordance with exemplary embodiments. Significant gains were observed thanks to the NumeroLogic encoding for all tasks where performance is not saturated.

### Arithmetic Tasks With Larger Model

How the method scales to a larger model was also tested. For this experiment, a pretrained conventional foundational model was fine-tuned and the same five arithmetic tasks were tested again: addition, subtraction, multiplication, sine, and square root. For addition (5 digits), subtraction (5 digits), and multiplication (3 digits) were tested on two versions-integers and floating-point numbers. For generating a random N-digit floating point operand, an up to N-digit integer was first sampled and was divided by a denominator uniformly sampled from {10⁰, 10¹, . . . , 10^{N}}. For each of the addition, subtraction, and multiplication tasks, 300,000 random equations were generated as a training set. The sine and square root operands and results were generated with five decimal place accuracy; 30,000 random equations were generated for the training sets of these tasks. Since a pretrained model is being used, new tokens (“<sn>”, “<mn>”, and “<en>”) were added to the tokenizer's vocabulary. One model per task was fine-tuned with LoRA (rank 8), and also trained the embedding layer and the final fully-connected layer in full-rank since their parameters were extended to accommodate the larger vocabulary size.

The results are presented in FIG. 2B. Addition and subtraction of integers are mostly solved by a model as large as the conventional foundational model even for much larger numbers (e.g. 20-digit). For the disclosed 5-digit experiments, the plain text baselines reached 99.86% and 99.6% performance for addition and subtraction, respectively. Despite the high performance of plain text, an improvement was still observed when using NumeroLogic with a perfect 100% for addition and rectification of more than 80% of the subtraction mistakes, reaching 99.93% accuracy for subtraction. For all other non-saturated tasks, significant gains of 1%-6% were observed.

### Self-Supervised Pretraining

In one aspect, the disclosed approach differs from other methods in that it is not specialized for a specific task, such as arithmetic tasks, but is rather designed for general language modeling tasks involving text with numerical values. To test this capability, the pretraining of the conventional foundational model was continued with the causal text modeling objective (next token prediction). Training on text from a conventional English dataset was performed. The goal is to teach the model to read and write numbers in the NumeroLogic format without forgetting its previously acquired knowledge. To facilitate this, the continued pretraining with LoRA was performed, and the model was then tested in a zero-shot manner on the massive multitask language understanding benchmark (MMLU).

FIG. 2C is a table that illustrates the MMLU accuracy change due to NumeroLogic encoding on tasks from different fields, in accordance with exemplary embodiments. Science, technology, engineering and mathematics (STEM) tasks, which are more likely to require numerical understanding, enjoy higher improvement.

FIG. 2D is a table that illustrates MMLU accuracy change due to NumeroLogic encoding on tasks with and without numbers, in accordance with exemplary embodiments. Tasks with numbers enjoy higher improvement.

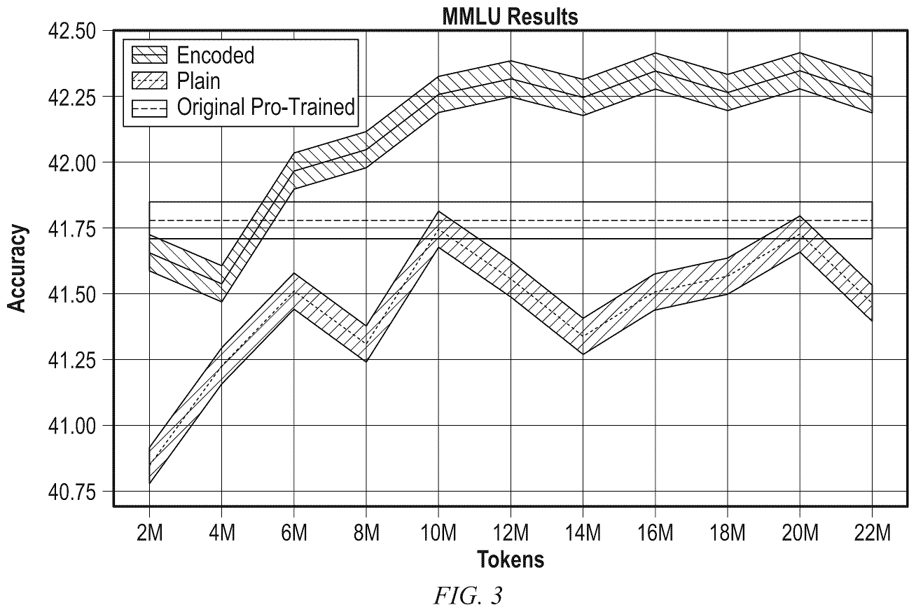

FIG. 3 illustrates MMLU accuracy of the conventional foundational model, in accordance with exemplary embodiments. Continuing self-supervised pretraining on web-curated text tokens, when numbers are encoded with NumeroLogic, helps improve the performance beyond the pretrained model or a model trained on the same text with plain numbers.

In FIG. 3, the MMLU 0-shot results obtained from training the model using plain numbers versus NumeroLogic encoding on an equal number of tokens is presented. While training with plain numbers does not enhance the model's accuracy compared to the pretrained model, employing NumeroLogic encoding results in a statistically significant improvement of 0.5%. The MMLU benchmark encompasses tasks from diverse domains, some emphasizing analytical skills and numerical comprehension while others do not. In the table of FIG. 2C, the impact of NumeroLogic on MMLU tasks categorized by field is delved into. As anticipated, tasks in STEM fields exhibit more substantial enhancements compared to those in social sciences and humanities. FIG. 2D provides a detailed analysis of NumeroLogic's performance boost across tasks containing numbers versus those that do not. Consistently, tasks involving numbers show a more pronounced improvement.

FIG. 2E is a table that illustrates the results of the effect of encoding the equation's operands vs. the result, in accordance with exemplary embodiments. Testing was performed on the addition task with the conventional language model. Either encoding the operands (i.e. input comprehension) or encoding the results (i.e. CoT effect) have a positive effect, with a stronger effect for operands'encoding. Encoding both the operands and the result provides the best performance.

FIG. 2F is a table that illustrates the results of using different encoding alternatives for 3-digit multiplication, in accordance with exemplary embodiments.

### Encoding Operands vs. Results

Experiments were conducted to test the effect of operand encoding vs. the expected output (equation result) encoding. Operand encoding primarily influences the model's comprehension of numerical values in the input, while the encoding of an equation's result is more associated with CoT, prompting the model to first reason about the expected number of digits. The experiment from the section entitled “arithmetic tasks with small model” was repeated, but with the NumeroLogic encoding applied only to the operands or to the results; the 3-digit addition results for the different variants are presented in FIG. 2E. It was found that both operands and results encodings are beneficial, with a stronger impact attributed to encoding the results. Applying NumeroLogic to all numbers, both operands and results, yields the highest level of accuracy.

### Different Encodings

Experiments were conducted with different formats for providing the number of digits. One alternative tested was defining a set of new special tokens representing each possible number of digits, {<1digitnumber>, <2digitnumber>, . . . }. It was observed that the performance of having multiple special tokens is even lower than plain numbers. This might be due to the unbalanced distribution of numbers; for example, since numbers with a single digit are much less frequent in data of 3-digit additions, it is possible the model has not seen enough single-digit numbers to learn a good representation of the <1digitnumber>token. Another alternative tested was removing the “end of number” token (<en>), keeping only the number prefix, e.g. “<sn>3<mn>100”. This works better than plain but slightly worse than the full NumeroLogic encoding. The results are summarized in FIG. 2F.

Given the discussion thus far, it will be appreciated that, in general terms, an exemplary method, according to an aspect of the invention, includes the operations of obtaining a numerical value; preprocessing the numerical value by adding a digit count before the numerical value to generate a modified numerical value, the digit count indicating a count of digits in the numerical value (operation 216); providing the modified numerical value to a machine learning model pretrained to understand the modified numerical value that comprises the digit count; and processing the modified numerical value using the pre-trained machine learning model. In exemplary embodiments, the processing the modified numerical value using the pre-trained machine learning model is performed to better understand the numerical value.

In exemplary embodiments, input data is obtained; a total number of digits of a new numerical value to be generated is predicted using the machine learning model based on the input data; and the new numerical value is generated using the machine learning model based on the predicted total number of digits and the input data.

In exemplary embodiments, the input data is pre-processed to enhance accuracy and speed in inferencing by obtaining and adding the count of digits to the input data for the machine learning model.

In exemplary embodiments, tokens are added to delineate portions of the modified numerical value to make the modified numerical value understandable to the machine learning model.

In exemplary embodiments, each token is one of a start number token, a mid-number token and an end number token to make the modified numerical value understandable to the machine learning model.

In exemplary embodiments, inferencing is performed using the machine learning model based on the modified numerical value.

In exemplary embodiments, the machine learning model is pretrained to understand the modified numerical value by recognizing a special format of the modified numerical value.

In exemplary embodiments, the pretrained machine learning model is fine-tuned on the special format using an adaptation technique (operation 228) and the processing the modified numerical value uses the fine-tuned, pre-trained machine learning model.

In exemplary embodiments, the pretraining of the machine learning model further comprises adding new special tokens to a vocabulary of a tokenizer corresponding to the machine learning model (operation 220); and an embedding layer and a final fully-connected layer of the machine learning model are expanded to accommodate the new special tokens of the vocabulary (operation 224).

In exemplary embodiments, the processing of the modified numerical value step generates an output number and the method further comprises applying a regular expression-based function to remove special formatting from the output number generated by the machine learning model and at least one plain number is returned (operation 232).

In one aspect, a computer program product comprises one or more tangible computer-readable storage media and program instructions stored on at least one of the one or more tangible computer-readable storage media, the program instructions executable by a processor, the program instructions comprising obtaining a numerical value; preprocessing the numerical value by adding a digit count before the numerical value to generate a modified numerical value, the digit count indicating a count of digits in the numerical value (operation 216); providing the modified numerical value to a machine learning model pretrained to understand the modified numerical value that comprises the digit count; and processing the modified numerical value using the pre-trained machine learning model.

In one aspect, an apparatus comprises a memory and at least one processor, coupled to the memory, and operative to perform operations comprising obtaining a numerical value; preprocessing the numerical value by adding a digit count before the numerical value to generate a modified numerical value, the digit count indicating a count of digits in the numerical value (operation 216); providing the modified numerical value to a machine learning model pretrained to understand the modified numerical value that comprises the digit count; and processing the modified numerical value using the pre-trained machine learning model.

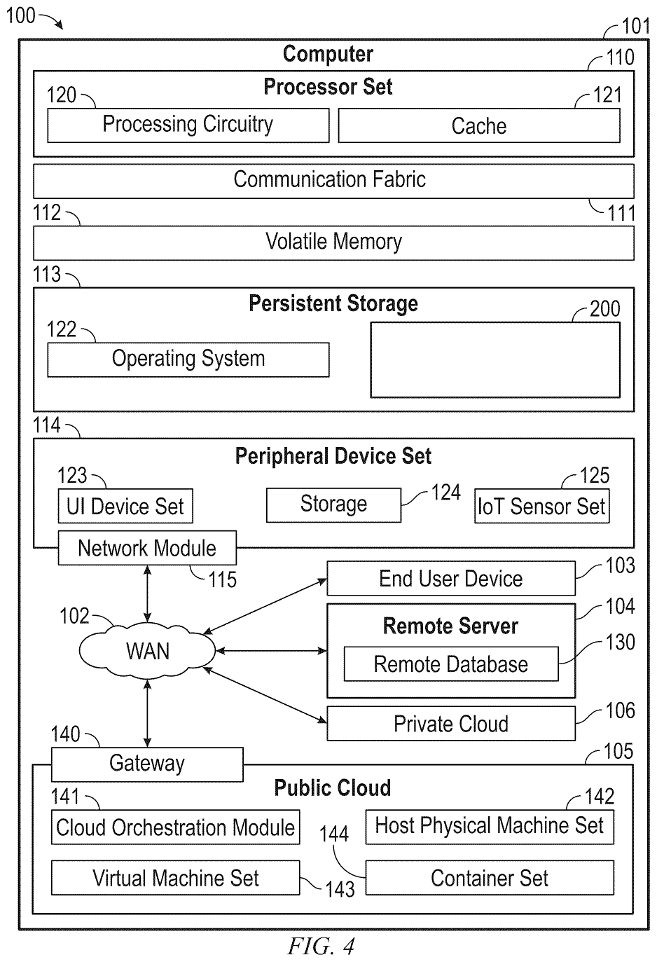

Refer now to FIG. 4.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 4. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining a numerical value;
preprocessing the numerical value by adding a digit count before the numerical value to generate a modified numerical value, the digit count indicating a count of digits in the numerical value;
providing the modified numerical value to a machine learning model pretrained to understand the modified numerical value that comprises the digit count; and
processing the modified numerical value using the pretrained machine learning model.

2. The method of claim 1, further comprising:
obtaining input data;
predicting, using the machine learning model, a total number of digits of a new numerical value to be generated based on the input data; and
generating, using the machine learning model, the new numerical value based on the predicted total number of digits and the input data.

3. The method of claim 2, further comprising pre-processing the input data to enhance accuracy and speed in inferencing by obtaining and adding the count of digits to the input data for the machine learning model.

4. The method of claim 1, further comprising adding tokens to delineate portions of the modified numerical value to make the modified numerical value understandable to the machine learning model.

5. The method of claim 4, wherein each token is one of a start number token, a mid-number token and an end number token to make the modified numerical value understandable to the machine learning model.

6. The method of claim 1, further comprising performing inferencing using the machine learning model based on the modified numerical value.

7. The method of claim 1, further comprising pretraining the machine learning model to understand the modified numerical value by recognizing a special format of the modified numerical value.

8. The method of claim 7, further comprising fine-tuning the pretrained machine learning model on the special format using an adaptation technique, wherein the processing of the modified numerical value uses the fine-tuned, pre-trained machine learning model.

9. The method of claim 7, wherein the pretraining of the machine learning model further comprises:
adding new special tokens to a vocabulary of a tokenizer corresponding to the machine learning model; and
expanding an embedding layer and a final fully-connected layer of the machine learning model to accommodate the new special tokens of the vocabulary.

10. The method of claim 1, wherein the processing of the modified numerical value step generates an output number, further comprising applying a regular expression-based function to remove special formatting from the output number generated by the machine learning model and to return at least one plain number.

11. A computer program product, comprising:
one or more tangible computer-readable storage media and program instructions stored on at least one of the one or more tangible computer-readable storage media, the program instructions executable by a processor, the program instructions comprising:
obtaining a numerical value;
preprocessing the numerical value by adding a digit count before the numerical value to generate a modified numerical value, the digit count indicating a count of digits in the numerical value;
providing the modified numerical value to a machine learning model pretrained to understand the modified numerical value that comprises the digit count; and
processing the modified numerical value using the pre-trained machine learning model.

12. A system comprising:
a memory; and
at least one processor, coupled to said memory, and operative to perform operations comprising:
obtaining a numerical value;
preprocessing the numerical value by adding a digit count before the numerical value to generate a modified numerical value, the digit count indicating a count of digits in the numerical value;
providing the modified numerical value to a machine learning model pretrained to understand the modified numerical value that comprises the digit count; and
processing the modified numerical value using the pre-trained machine learning model.

13. The system of claim 1, wherein the operations performed by the at least one processor further comprise:
obtaining input data;
predicting, using the machine learning model, a total number of digits of a new numerical value to be generated based on the input data; and
generating, using the machine learning model, the new numerical value based on the predicted total number of digits and the input data.

14. The system of claim 13, wherein the operations performed by the at least one processor further comprise pre-processing the input data to enhance accuracy and speed in inferencing by obtaining and adding the count of digits to the input data for the machine learning model.

15. The system of claim 1, wherein the operations performed by the at least one processor further comprise adding tokens to delineate portions of the modified numerical value to make the modified numerical value understandable to the machine learning model.

16. The system of claim 1, wherein the operations performed by the at least one processor further comprise performing inferencing using the machine learning model based on the modified numerical value.

17. The system of claim 1, wherein the operations performed by the at least one processor further comprise pretraining the machine learning model to understand the modified numerical value by recognizing a special format of the modified numerical value.

18. The system of claim 7, wherein the operations performed by the at least one processor further comprise fine-tuning the pretrained machine learning model on the special format using an adaptation technique and wherein the processing the modified numerical value uses the fine-tuned, pre-trained machine learning model.

19. The system of claim 7, wherein the pretraining of the machine learning model further comprises:
adding new special tokens to a vocabulary of a tokenizer corresponding to the machine learning model; and
expanding an embedding layer and a final fully-connected layer of the machine learning model to accommodate the new special tokens of the vocabulary.

20. The system of claim 1, wherein the processing of the modified numerical value generates an output number and wherein the operations performed by the at least one processor further comprise applying a regular expression-based function to remove special formatting from the output number generated by the machine learning model and return at least one plain number.
